(19) United States
(12) Patent Application Publication
(10) Pub. No.: US 2013/0276992 A1
(43) Pub. Date: Oct. 24, 2013

(54) FEEDER

(71) Applicants: Tsung-Chih TSAI, Tu-Cheng (TW); Chao-An KANG, Tu-Cheng (TW); Shang-Yu LIN, Tu-Cheng (TW)

(72) Inventors: Tsung-Chih TSAI, Tu-Cheng (TW); Chao-An KANG, Tu-Cheng (TW); Shang-Yu LIN, Tu-Cheng (TW)

(21) Appl. No.: 13/662,668

(22) Filed: Oct. 29, 2012

(30) Foreign Application Priority Data
Apr. 24, 2012 (TW) 101114601

(51) Int. Cl. B32B 38/10; B32B 41/00

(52) U.S. Cl. 156/751; 156/750

(57) ABSTRACT

A feeder capable of transferring and separating an adhesive component from a tap, includes a frame, a driven capstan device, a separating device, and a drive device. The driven capstan device is mounted to the frame. The separating device is mounted to the frame to separate the adhesive component from the tap. The drive device drives the tap to unwind from the driven capstan and transfer to the separating device to enable the separating device to separate the adhesive component.

### BACKGROUND

1. Technical Field

The present disclosure relates to feeders, particular to a label feeder.

2. Description of Related Art

A printed circuit board is often affixed with labels for identifying components or to show information about the printed circuit board. The labels are affixed to the printed circuit board manually. As such, the labels may pick up grease and other contaminants or the labels may be damaged during attachment

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a feeder.

FIG. 2 is an enlarged view of circle II of FIG. 1.

FIG. 3 is a partial of the feeder in FIG. 1 but viewed the feeder from another angle.

### DETAILED DESCRIPTION

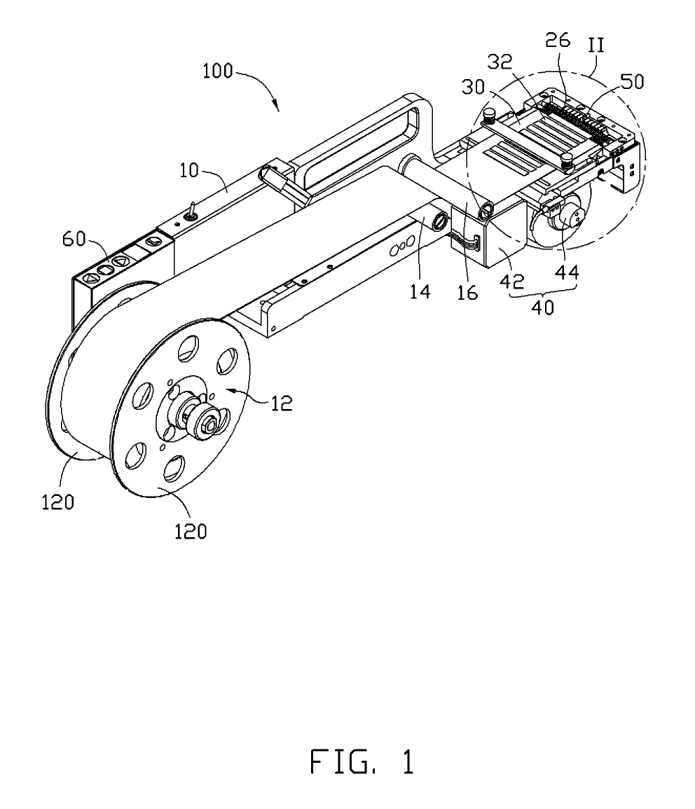

Referring to FIG. 1, a feeder 100 in accordance with one embodiment, is shown. The feeder 100 is capable of separating adhesive components 32 from a tap 30. The adhesive component 32 may be a label, an insulating plate, a cushion, for example. In the embodiment, the adhesive component 32 is a label. The adhesive components 32 are separately affixed on the tap 30 at intervals.

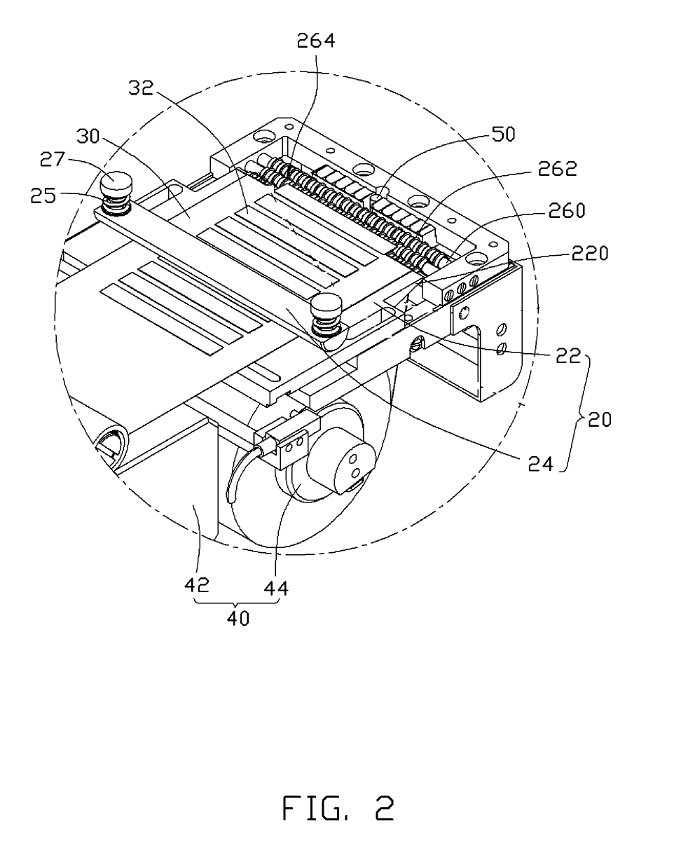

The feeder 100 includes a frame 10, a driven capstan device 12, a first idler roller 14, a second idler roller 16, a separating device 20 (see FIG. 2), a drive device 40, a detector 50, a controller 60, and a supporting platform 26.

The driven capstan device 12 and the separating device 20 are mounted to opposite ends of the frame 10. The first idler roller 14 and the second idler roller 16 are rotatably mounted to the frame 10, and positioned between the driven capstan device 12 and the separating device 20. The tap 30 winds around the driven capstan device 12, then is passed across the first idler roller 14, then is passed down the second idler roller 16 and is pressed by the second idler roller 16, and then transferred to the separating device 20 to separate the adhesive components 32 from the tap 30. The supporting platform 26 is adjacent to the separating device 20 and away from the second idler roller 16 to support each pealed adhesive component 32. The drive device 40 drives the tap 30 to transfer to the separating device 20. The detector 50 detects each pealed adhesive component 32. The controller 60 controls the drive device 40 to work when the detector 50 does not detect the peeled adhesive component 32.

The driven capstan device 12 includes two parallel blocking plates 120, and a capstan roller (not shown) rotatably connected between the two plates 120. The tap 30 winds around the capstan roller, and has a free end without the adhesive component 32. The two blocking plates 120 are blocked at opposite sides of the tap 30 to enable the tap 30 smoothly transferred to the separating device 20.

The first idler roller 14 and the second idler roller 16 are parallel to the capstan roller. The second idler roller 16 is adjacent to the separating device 20 and is positioned under the first idler roller 14. The first idler roller 14 is adjacent to the second idler roller 16.

Referring to FIG. 2, the separating device 20 includes a separator 22, and a tensioning member 24. The tensioning member 24 is secured to the middle of the separator 22. The tensioning member 24 is a strip board which is parallel to the first idler roller 14 and the second idler roller 16. Opposite ends of the tensioning member 24 are secured to the separator 22 via a pair of securing members 27, and capable of moving with respect to the securing members 27. A par of elastic members 25 are sleeved on the securing members 27, one end of the elastic member 25 contacts the tensioning member 24, and the other end of the elastic member 25 contacts the secured member 27, such that the tensioning member 24 is prevented from moving by the elastic member 25. The separator 22 is a rectangular board. There is a gap formed between the tensioning member 24 and the separator 22 to allow the tap 30 being transferred to the separator 22. One end of the separator 22 away from the tensioning member 24 sets a wedge shaped peeling bar 220.

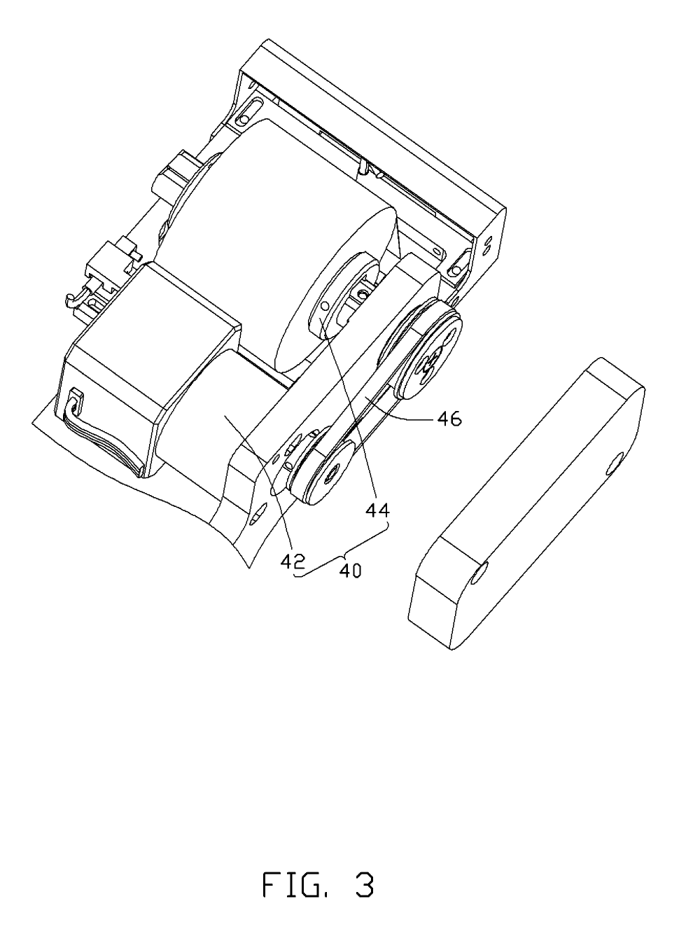

Referring to FIG. 3, the drive device 40 of one embodiment is shown. The drive device 40 includes a drive motor 42 and a drive capstan device 44. The drive motor 42 and the drive capstan device 44 are secured to the frame 10 under the separator 22. The free end of the tap 30 is secured to the drive capstan device 44, such that the tap 30 turns sharply through an angle greater than 90 degree to cause one end of the lead edge of the adhesive member 22 to separate from the tap 30. The drive motor 42 drives the drive capstan device 44 to rotate via a belt 46, such the tap 30 is wound around the drive capstan device 44, and the tap 30 continues to be driven to unwind from the driven capstan device 12 and be advanced around the peeled bar 220, the adhesive component 32 becomes progressively peeled from the tap 30 and ultimately entirely separated from the tap 30.

Referring to FIG. 2 again, the supporting platform 26 includes three parallel supporting rollers 260 which are adjacent to the peeling bar 220. The supporting roller 26 is a screw shaft which has a circumferential ridge 262 around the surface of the supporting rollers 260. The supporting rollers 260 are positioned on a plane, and a supporting surface 264 coplanar with the surface of the separator 22 contacting the tap 30 is formed. The supporting surface 26 supports and presents the peeled adhesive component 32.

Referring to FIGS. 1 and 2 again, the detector 50 and the controller 60 are secured to the frame 10. The detector 50 is adjacent to the supporting member 26 and opposite to the separator 22. The controller 60 is adjacent the driven capstan device 12. The detector 50 generates a first control signal when the detector 50 does not detect the peeled adhesive component 32, and generates a second control signal when the detector 50 detects the peeled adhesive component 32. The controller 60 controls the drive motor 42 to work in response to the first control signal, such that the tap 30 can be transferred. The controller 60 controls the drive motor 42 to stop working in response to the second control signal, such that the tap 30 can not be transferred.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A feeder for transferring and separating an adhesive component from a tap, the feeder comprising:
a frame;
a driven capstan device mounted to the frame;
a separating device mounted to the frame to separate the adhesive component from the tap; and
a drive device to drive the tap to unwound from the driven capstan and transferred to the separating device, as to enable the separating device to separate the adhesive component.

2. The feeder of claim 1, wherein the separating device comprises a separator, one end of the separator sets a peeling bar for separating the adhesive component from the tap, the tap is transferred around the peeling bar and then secured to the drive device.

3. The feeder of claim 1, wherein the separating device further comprises a tightening member, the tightening member is secured to the separator, the tap is transferred between the tightening member and the separator to the peeling bar.

4. The feeder of claim 1, wherein feeder further comprises a securing member, and an elastic member, the tightening member is secured to the separator via the securing member and capable of moving with respect to the securing member, and one end of the elastic member contacts the tightening member, the other end of the elastic member contacts the securing member to prevent the tightening member from moving.

5. The feeder of claim 1, wherein the feeder further comprises a supporting platform adjacent to the separating device, the supporting platform comprises a plurality of supporting rollers for supporting the peeled adhesive component, each supporting roller comprising a ridge around a surface of the supporting roller.

6. The feeder of claim 1, wherein the feeder further comprises a detector and a controller, the detector is capable of detecting the peeled adhesive component and generating a control signal when the peeled adhesive component is not detected, the controller is capable of controlling the drive device to drive the tap to unwind in response to the control signal.

7. The feeder of claim 1, wherein the drive device comprises a drive motor, and a drive capstan device, the tap is secured to the drive capstan device when the tap is transferred from the separating device; and the drive motor drives the drive capstan device to wind the tap which is transferred from the separating device, to drive the tap unwind from the driven capstan device.

8. A feeder for transferring and separating an adhesive component from a tap, the feeder comprising:
a frame;
a separating device mounted to the frame to separate the adhesive component from the tap;
a drive device drive the tap to be transferred to the separating device, as to enable the separating device to separate the adhesive component; and
a detector detecting the peeled adhesive component, the detector generating a control signal to control the drive device to drive the tap to transfer to the separating device when the peeled adhesive component is not detected.

9. The feeder of claim 8, wherein the separating device comprises a separator, one end of the separator sets a peeling bar for separating the adhesive component, the tap is transferred around the peeling bar and then secured to the drive device.

10. The feeder of claim 9, wherein the separating device further comprises a tightening member, the tightening member is secured to the separator, the tap is transferred between the tightening member and the separator to the feeling bar.

11. The feeder of claim 10, wherein feeder further comprises a securing member, and an elastic member, the tightening member is secured to the separator via the securing member and capable of moving with respect to the securing member, and one end of the elastic member contacts the tightening member, the other end of the elastic member contacts the securing member to prevent the tightening member from moving.

12. The feeder of claim 8, wherein the feeder further comprises a supporting platform adjacent to the separating device, the supporting platform comprises a plurality of supporting rollers for supporting the peeled adhesive component, each supporting roller comprising a ridge around a surface of the supporting roller.

13. The feeder of claim 8, wherein the feeder further comprises a detector and a controller, the detector is capable of detecting the peeled adhesive component and generating a control signal when the peeled adhesive component is detected, the controller is capable of controlling the drive device to drive the tap to transfer to the separating device in response to the control signal.

14. The feeder of claim 8, wherein the drive device comprises a drive motor, and a drive capstan device, the tap is secured to the drive capstan device when the tap is transferred from the separating device; the drive motor drives the drive capstan device to wind the tap which is transferred from the separating device, to drive the tap to transfer to the separating device.
